(19) United States
(12) Patent Application Publication
(10) Pub. No.: US 2014/0278087 A1
(43) Pub. Date: Sep. 18, 2014

(54) Method and Apparatus for Predicting Times of High Driver Demand

(71) Applicant: FORD GLOBAL TECHNOLOGIES, LLC, Dearborn, MI (US)

(72) Inventors: Kwaku O. Prakah-Asante, Commerce Township, MI (US); Hsin-Hsiang Yang, Ann Arbor, MI (US); Gary Steven Strumolo, Canton, MI (US)

(73) Assignee: FORD GLOBAL TECHNOLOGIES, LLC, Dearborn, MI (US)

(21) Appl. No.: 13/804,401

(22) Filed: Mar. 14, 2013

(51) Int. Cl. G01C 21/26

(52) U.S. Cl. CPC G01C 21/26
USPC 701/532

(57) ABSTRACT

A system includes a processor configured to receive information representing a driver demand level for a plurality of driving locations. The processor is further configured to aggregate the received information to identify likely high driving demand areas. The processor is additionally configured to access stored aggregated driving demand information to identify likely high driving demand areas on a current vehicle route. Also, the processor is configured to provide one or more services to reduce driver inattentiveness and to elevate driver focus during travel within the identified areas, based on upcoming identified likely high driving demand areas.

### TECHNICAL FIELD

The illustrative embodiments generally relate to a method and apparatus for predicting times of high driver demand.

### BACKGROUND

Drivers are provided connected services and information within the vehicle-cabin for convenient and efficient driving experiences. It is important that information is provided to the driver at appropriate times to minimize inconvenience. OEMs are expanding the envelope, and designing features and methods that deliver a connected experience for customers with systems that anticipate and assist driver attention.

U.S. Pat. No. 8,301,108 generally relates to a safety control system for vehicles, includes, a communication device having at least one of an input accessible from within the vehicle and an output communicated within the vehicle, at least one sensor operable to sense at least one condition related to vehicle operation, and a controller communicated with the sensor and the communication device to selectively suppress at least one of said input and said output in response to a sensed parameter of said at least one condition being outside of a threshold. When an input is suppressed, the driver is prevented from accessing or inputting information into the communication device. When an output is suppressed, communication between the device and the driver of a vehicle is suppressed to, among other things, avoid distracting the driver during certain driving situations or conditions relating to the driver, vehicle and/or environment

U.S. Patent Application 2004/0088205 generally relates to a method for estimating workload placed on the driver of a vehicle. The method comprises receiving workload estimation data. A driving workload estimate is calculated in response to the workload estimation data. The driving workload estimate is indicative of current and previously occurring conditions. The driving workload estimate is then output.

### SUMMARY

In a first illustrative embodiment, a system includes a processor configured to receive information representing a driver demand level for a plurality of driving locations. The processor is further configured to aggregate the received information to identify likely high driving demand areas. The processor is additionally configured to access stored aggregated driving demand information to identify likely high driving demand areas on a current vehicle route. Also, the processor is configured to provide one or more services to reduce possible driver inattentiveness and to elevate driver focus during travel within the identified areas, based on upcoming identified likely high driving demand areas.

In a second illustrative embodiment, a computer-implemented method includes receiving information representing a driver demand level for a plurality of driving locations. The method also includes aggregating the received information to identify likely high driving demand areas. Further, the method includes accessing stored aggregated driving demand information to identify likely high driving demand areas on a current vehicle route. The method also includes providing one or more services to reduce possible driver inattentiveness and to elevate driver focus during travel within the identified areas, based on upcoming identified likely high driving demand areas.

In a third illustrative embodiment, a non-transitory computer readable storage medium stores instructions that, when executed by a processor, cause the processor to perform a method including receiving information representing a driver demand level for a plurality of driving locations. The method also includes aggregating the received information to identify likely high driving demand areas. Additionally, the method includes accessing stored aggregated driving demand information to identify likely high driving demand areas on a current vehicle route and, based on upcoming identified likely high driving demand areas, providing one or more services to reduce possible driver inattentiveness and to elevate driver focus during travel within the identified areas.

### BRIEF DESCRIPTION OF THE DRAWINGS

FIG. 1 shows an illustrative vehicle computing system;

FIG. 2 shows an illustrative block diagram for predictive driving demand and services coordination;

FIG. 3 shows several examples of predicted areas of demand along a route;

FIG. 4 shows a conflux of the predicted demand areas;

FIG. 5 shows an illustrative process for predicting driver demand; and

FIG. 6 shows an illustrative process for integrating predicted demand with delivered services.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

While current systems are capable of driver demand evaluation, it would be useful to predict driver demand ahead while driving, to enhance delivery of the type of connectivity information provided to the driver in the cabin. Intelligent anticipation of high demand occurrences while driving vehicles assists in further coordination of information for VCS systems, application developers, and connected services.

The illustrative embodiments describe new systems and methods for telematics and driving demand informatics synthesis for Predictive Driving Demand and connected Services coordination (PDDS). The new PDDS systems and methods forecast upcoming high driving demand situations by selecting and recording frequently repeated high demand driving experiences and locations. Based on forecasted regions for high driving demand, connectivity information is coordinated ahead of time, for features such as, but not limited to, Intelligent Do Not Disturb (iDND), an Intelligent High Attention Caution (iHAC) reminder system, and any other suitable features.

Regions where the driving demand and workload tends to be high are synergistically computed by learning over time, by fusing available latitude/longitude telematics information with computed real-time driving demand and workload information. Regions of high driving demand are recursively stored and updated based on the likelihood of occurrence.

In one illustrative PDDS, components include: a Driver Input Interaction Subsystem; Intervallic Driving Demand and Workload Subsystem; Driving Demand Likelihood Learning; Self-Tuning Predictive Driving Demand; and iHAC & DND Driver Personalized Interaction. The PDDS provides a predictive continuous index value of upcoming driving demand conditions for connected services information management. The iHAC real-time reminder features provide drivers with recommendations on predictive driving demand situations based on a learning system.

Using the illustrative embodiments and the like, VCS do not disturb (DND) may be automatically activated ahead of demanding driving conditions to mitigate potential driving distraction. Alert for the iHAC system may be provided utilizing existing vehicle outputs. This can be used to alert the driver of upcoming predicted high-demand situations, if desired. Through the learning approaches presented herein, minimal memory storage for real-time applications needs to be used. The PDDS and iHAC provide direct driver input for individual preferences for connectivity services and information management. Application developers can also utilize configurable messages provided to the iDND and iHAC for customizing messages to users.

FIG. 2 shows an illustrative block diagram for predictive driving demand and services coordination. This is an illustrative example of an embodiment of a system for PDDS. The system includes a module for intervallic attention demand and workload computation (ADWC) 211. This module receives inputs from the environment 217, vehicle responses 215 and driver action inputs 203 from a driver 201. These inputs help demonstrate and measure how much demand is placed on a driver at a given time. Environment information can include, but is not limited to, observed vehicles in proximity to the driver's vehicle, distances to observed vehicles, road conditions and other information about the area around the vehicle. Driver action inputs can include, but are not limited to, turning, frequency of steering adjustments, lane changes, braking, acceleration and other control inputs. Vehicle response information can include traction-control engagement, speed, pitch, slippage and other similar information.

The system also includes a driving demand likelihood (DDLL) module, which provides, adaptation and configuration of the likelihood of demand at a given location. This module receives inputs from telematics, such as GPS information 219, to determine locations at which the ADWC calculates high demand situations. The ADWC also provides inputs to this system, so that demand can be measured and observed at a given location.

This information is fed into a self-tuning and predictive driving demand workload (STDD) module 221. The STDD module can provide the predicted information to functions such as iDND and iHAC 207, 205. The intelligent systems and functions can then provide driver inattentiveness reducing services and to elevate driver focus when areas of likely high driving demand are upcoming. Connectivity services 223 feed into a personalized adaptive driver communication system 209 that can be used to control connectivity when areas of high driving demand are upcoming. Personalized driver communication can be provided based on the predicted driving demand and connected services information. The iHAC real-time reminder module can provide drivers with recommendations based on upcoming predicted driving demand situations as delivered from the learning system. Functions such as do not disturb (DND) can be intelligently activated ahead of demanding driving conditions from an iDND module.

Learning about possible high driving demand situations and storing those situations can be useful for the functionality of the PDDS systems and methods. High driving demand situations are commonly associated with high traffic density, lane changing, or road geometry. Other high driving demand situations may be associated with extreme weather, and the system could observe that a weather condition combined with a medium demand area may be likely to result in a high driving demand area. Since traffic, weather, and lane-changing vary with time and other drivers, the most commonly recurring predictable situation involves road geometry, as this does not typically change absent major construction.

The ADWC identifies driving demand situations as a driver progresses along a route. Among other things, the ADWC can determine not only driving demand, but possible causes of the demand as well. If certain high driving demand situations have a high enough likelihood of repetition, the DDLL system may record those situations automatically. Subsequently, when the driver approaches recorded high driving demand situations, the STDD can anticipate the driver's activity.

High driving demands due to road geometry have a high likelihood of repetition every time the driver is in the location where they occur. In addition, if a driver has a high workload every time in the same location, it is most likely to be a high driving demand location. Based on the frequency of high demand occurrence, the locations of high demand are identified. Once the likelihood of a location over time exceeds a tunable threshold, that location may be characterized as a high driving demand location for personalized driver adaptive communication.

The ADWC workload estimator (WLE) algorithms may run in real-time during vehicle trips to provide a WLE index that measures the demand over a given trip at given locations. If the WLE index exceeds a threshold at a particular location, the GPS coordinates relating to that location may be stored and an initial likelihood of high driving demand may be provided. For each of n locations i, the GPS coordinates L may be stored with respect to an initial likelihood p₀. This can be described by:

L_{i(GPS}_{ₗₐₜ}_{,GPS}_{_{long}}₎=p₀ where i=1, . . . ,n

During each trip, if the vehicle drives through a similar range of GPS coordinates of Lᵢ and the vehicle has another high WLE above a threshold value, then:

Lᵢ₊₁(GPSₗₐₜ,GPS_{long})=α·Lᵢ+(1−α)·p₀

Otherwise, if the WLE is below the threshold, then:

Lᵢ₊₁(GPSₗₐₜ,GPS_{long})=α·Lᵢ

Where α is a decaying factor. Thus, if p₀ is the WLE_Index, then the WLE above threshold equation becomes:

Lᵢ₊₁(GPSₗₐₜ,GPS_{long})=α·Lᵢ+(1−α)·WLE_Index(i)

While the WLE_below_threshold will decay the value over time, indicating that the observed high WLE_Index is not commonly recurring.

In another illustrative embodiment, likelihood constants may be chosen for p₀ in the WLE above threshold equation such that:

$${p}_{0} = \{ \begin{matrix}γ ( initialization ) \\ α ( update )\end{matrix}$$

FIG. 3 shows several examples of predicted areas of demand along a route. The route may consist of local surface streets, arterial streets, and highways. An instrumented vehicle can be used for obtaining real-time data for evaluation. FIG. 3 shows two trips along the route, with highlighted high WLE locations.

The trip starts at location 301 and continues to location 307. The route 309 is designated between the points. Elements 312 and 308 mark areas of high WLE index. A grid defines the locations along the road and may be based on Latitude 303 and Longitude 305.

In the second trip, the elements 311 and 313 define the areas of high WLE index. As can be seen, 311 and 313 occur at different points on the second trip than areas 308 and 312 on the first trip. As the driver drives these routes repeatedly, this process will aggregate areas of high WLE indexes and these can be combined to determine frequently recurring areas of high WLE index.

FIG. 4 shows a conflux of the predicted demand areas. This map 401 is an aggregate of the maps shown in FIG. 3. The areas 313 and 308 overlap at 401, and the areas 311 and 312 overlap at 403. The areas of overlap 401, 403 designate areas where high WLE indexes with increased computed likelihood of occurrence have occurred in both trips. As more trips are accrued, the process will be able to refine these areas with greater and greater degrees of distinction.

Whenever the likelihood Lᵢ reaches a designated tunable sensitivity level, the corresponding location is regarded as a high likelihood for driving demand. On the other hand, if Lᵢ drops below a threshold level, an area can be removed to save memory storage, or targeted for features which need information for potential low-demand scenarios.

The STDD and workload module provides advanced information about upcoming high demand situations. Whenever the likelihood Lᵢ reaches a designated tunable sensitivity level, the corresponding location is regarded as a high driving demand location for the driver and feature requirements.

Personalized adaptive driver communication (PADC) is provided based on the predicted driving demand and connected services information. The iHAC feature delivers personalize real-time reminders for drivers with recommendations on upcoming driving demand situations. The VCS DND feature can be automatically activated ahead of demanding driving conditions for select connected services.

FIG. 5 shows an illustrative process for predicting driver demand. In this illustrative embodiment, the process acts to gather information and predict areas of high driver demand. While the driver is traveling along the road, the process obtains real-time driver, vehicle response and environmental inputs 501. This information can be used to update the predictive calculations for areas along the route, so that future information can be delivered with a greater degree of accuracy.

Using vehicle telematic information and calculating short term workload 503, the process determines real-time demands for the vehicle's present location. This information is added to the collective, whenever the calculated WLE_index is above a certain threshold. When the WLE_index is below the threshold, the likelihood factor for a given location degrades.

Driving demand likelihood learning (DDLL) may compute and store likelihood values for upcoming locations with a potential for high workload 505. This information is based on the previously observed information from previous trips along the route. If Lᵢ is above a threshold value β the process sends the likelihood value and telemetry location to the STDD 509.

FIG. 6 shows an illustrative process for integrating predicted demand with delivered services. In this example, the STDD receives Lᵢ when Lᵢ is above the threshold value. The STDD monitors current telematic locations, current computed driving demand and DDLL values. The STDD can also provide feature dependent current and future driving demand and workload values based on information received from the other modules 601.

If there is a high index value for a given location, the process determines if the driver has selected iHAC. As previously noted, iHAC provides warnings and alerts to drivers for upcoming areas of high likelihood 603.

If iHAC is enabled, the PADC can provide personalized driver demand reminders 607. These reminders can be based on predicted driving demand and connected services information. For example, the system may alert a driver that certain connected services will not be available in an upcoming area, so that the driver could utilize the connected services while they were still available. The iHAC can also provide reminders about connected services, such as warnings that touch capability may not be available 609.

Similarly, the process may check to see if iDND is enabled 605. Again, PADC can provide personalized driver demand reminders 611. iDND can automatically enable do not disturb functionality for areas of high demand 613.

While the iHAC and iDND services are shown as exemplary services that may be employed in instances of high demand, any number of services may be implemented. Typically, these services will relate to reducing possible driver inattentiveness, elevating driver focus, providing driver convenience, and increasing safety.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive information representing a driver demand level for a plurality of driving locations;
aggregate the received information to identify likely high driving demand areas;
access stored aggregated driving demand information to identify likely high driving demand areas on a current vehicle route; and
based on upcoming identified likely high driving demand areas, provide one or more services to reduce driver inattentiveness and elevate driver focus during travel within the identified areas.

2. The system of claim 1, wherein the received information includes driver control inputs.

3. The system of claim 1, wherein the received information includes vehicle environment information.

4. The system of claim 1, wherein the received information includes vehicle response information.

5. The system of claim 1, wherein the processor is further configured to:
calculate an index value for the demand at each of the driving locations, wherein, if the index value is above a tunable threshold, the aggregation results in an increase of the likelihood of high driving demand for the location, and if the index value is below the tunable threshold, the aggregation results in a decrease of the likelihood of high driving demand for the location.

6. The system of claim 1, wherein the services include an automatic do not disturb enablement.

7. The system of claim 1, wherein the services include a warning presented to the driver about the upcoming high demand area.

8. A computer-implemented method comprising:
receiving information representing a driver demand level for a plurality of driving locations;
aggregating the received information to identify likely high driving demand areas;
accessing stored aggregated driving demand information to identify likely high driving demand areas on a current vehicle route; and
based on upcoming identified likely high driving demand areas, providing one or more services to reduce driver inattentiveness and elevate driver focus during travel within the identified areas.

9. The method of claim 8, wherein the received information includes driver control inputs.

10. The method of claim 8, wherein the received information includes vehicle environment information.

11. The method of claim 8, wherein the received information includes vehicle response information.

12. The method of claim 8, wherein the processor is further configured to:
calculate an index value for the demand at each of the driving locations, wherein, if the index value is above a tunable threshold, the aggregation results in an increase of the likelihood of high driving demand for the location, and if the index value is below the tunable threshold, the aggregation results in a decrease of the likelihood of high driving demand for the location.

13. The method of claim 8, wherein the services include an automatic do not disturb enablement.

14. The method of claim 8, wherein the services include a warning presented to the driver about the upcoming high demand area.

15. A non-transitory computer readable storage medium, storing instructions that, when executed by a processor, cause the processor to perform a method comprising:
receiving information representing a driver demand level for a plurality of driving locations;
aggregating the received information to identify likely high driving demand areas;
accessing stored aggregated driving demand information to identify likely high driving demand areas on a current vehicle route; and
based on upcoming identified likely high driving demand areas, providing one or more services to reduce driver inattentiveness and to elevate driver focus during travel within the identified areas.

16. The storage medium of claim 15, wherein the received information includes driver control inputs.

17. The storage medium of claim 15, wherein the received information includes vehicle environment information.

18. The storage medium of claim 15, wherein the received information includes vehicle response information.

19. The storage medium of claim 15, wherein the processor is further configured to:
calculate an index value for the demand at each of the driving locations, wherein, if the index value is above a tunable threshold, the aggregation results in an increase of the likelihood of high driving demand for the location, and if the index value is below the tunable threshold, the aggregation results in a decrease of the likelihood of high driving demand for the location.

20. The storage medium of claim 15, wherein the services include an automatic do not disturb enablement.
